(19) United States
(12) Patent Application Publication
(10) Pub. No.: US 2012/0316835 A1
(43) Pub. Date: Dec. 13, 2012

(54) ANOMALY DETECTION METHOD AND ANOMALY DETECTION SYSTEM

(76) Inventors: Shunji Maeda, Yokohama (JP); Hisae Shibuya, Chigasaki (JP)

(21) Appl. No.: 13/521,767

(22) PCT Filed: Dec. 16, 2010
(86) PCT No.: PCT/JP2010/072614

§ 371 Date: Jul. 12, 2012

(30) Foreign Application Priority Data
Jan. 14, 2010 (JP) 2010-005555

(51) Int. Cl. G06F 15/00

(52) U.S. Cl. 702/183

(57) ABSTRACT

A method and system for detecting an anomaly or a fault in equipment such as a plant. A method of representing the state of the equipment is offered. Output signals from multidimensional sensors are treated as subjects. (1) Normal learning data is created. (2) An anomaly measurement is calculated by a subspace classifier or other method. (3) Trajectories of motions of observational data and learning data are evaluated and their errors are calculated by a linear prediction method or the like. (4) The state of the equipment is represented using the anomaly measurement and the trajectories of the motions. (5) A decision is made regarding an anomaly. A case-based reasoning anomaly detection consists of modeling the learning data by the subspace classifier and detecting candidate anomalies based on the distance relationship between the observational data and the subspace. The trajectories of the motions are based on modeling using a linear prediction method.

### INCORPORATION BY REFERENCE

The present application claims the priority of Japanese Patent Application No. 2010-005555, filed on Jan. 14, 2010, the contents of which are incorporated herein by reference.

### TECHNICAL FIELD

The present invention relates to an anomaly detection method, anomaly detection system, and anomaly detection program for early detecting an anomaly or a fault in a plant, equipment, or the like.

### BACKGROUND ART

An electric power company utilizes waste heat or the like from gas turbines to supply warm water for providing regional heating or to supply high-pressure vapor or low-pressure vapor to plants. In petrochemical companies, gas turbines or the like are being run as power supply equipment. In various plants and equipment using gas turbines or the like in this way, it is quite important to be able to early discover anomalies or abnormalities because damage to the society can be suppressed to a minimum.

Anomalies or abnormalities such as deterioration and lifetime of installed batteries which must be discovered in early stages are not restricted to gas turbines and vapor turbines. Other innumerable examples of facilities include water turbines in water power plants, nuclear reactors in atomic power plants, wind turbines in wind power plants, engines in aircraft and heavy machinery, railway vehicles and rails, escalators, elevators, medical apparatus such as MRI, manufacturing equipment and inspection devices and even at levels of their tools and parts for semiconductors and flat panel displays. In recent years, it is becoming important to detect anomalies (various symptoms) of the human body as encountered in measurement and diagnosis of brain waves for the sake of health management.

Therefore, SmartSignal Corporation of the United States, for example, provides business services for detecting anomalies mainly in engines as described in Patent Literature 1 and Patent Literature 2. In particular, past data are held as a database (DB). The degree of similarity between observational data and past learning data is calculated by a unique method. An estimated value is calculated by a linear combination of data sets having high degrees of similarity. The degree of deviation between the estimated value and the observational data is output. The contents of Patent Literature 3 include an example in which an anomaly is detected by k-means clustering as in General Electric Co.

### CITATION LIST

### Patent Literature

Patent Literature 1: U.S. Pat. No. 6,952,662

Patent Literature 2: U.S. Pat. No. 6,975,962

Patent Literature 3: U.S. Pat. No. 6,216,066

### Non Patent Literature

Non Patent Literature 1: Stephan W. Wegerich; Nonparametric modeling of vibration signal features for equipment health monitoring, Aerospace Conference; 2003, Proceedings, 2003 IEEE, Volume 7, Issue, 2003 Page(s): 3113-3121

### SUMMARY OF INVENTION

### Technical Problem

Generally, a system that monitors observational data, compares the data with a set threshold value, and detects an anomaly is often used. In this case, the threshold value is set while taking notice of a physical amount of a subject to be measured that is each piece or set of observational data. Therefore, it can be said that the detection is design-based anomaly detection.

In this method, it is difficult to detect an anomaly which was not considered in the design. Failure to detect may occur. For example, it can be said that the set threshold value is no longer appropriate because of the effects of the environment in which the equipment is run, state variations due to years of operation, operating conditions, and replacement of parts.

On the other hand, in the technique based on case-based reasoning anomaly detection and used by SmartSignal Corporation, an estimated value of learning data is calculated by linear combinations of data having high degrees of similarity with observational data. A degree of deviation between the estimated value and the observational data is output. Consequently, depending on how the learning data is prepared, the effects of the environment in which the equipment is run, state variations due to years of operation, operating conditions, and replacements of parts can be taken into consideration.

However, in the technique of SmartSignal, data are treated as snap shots and thus temporal behaviors are not taken into account. Furthermore, additional explanation is necessary to know why anomalies are contained in the observational data. When an anomaly is detected within a feature space having a little physical meaning such as k-means clustering of General Electric, it is more difficult to explain away the anomaly. Where it is difficult to give an explanation, it is treated as a misdetection.

Accordingly, it is an object of the present invention to enable a case-based reasoning anomaly detection method to evaluate quality including temporal variations of observational data and learning data while maintaining the ability to be capable of taking account of the effects of the environment in which equipment is run, state variations due to years of operation, operating conditions, and replacement of parts depending on how the learning data has been prepared. As such, an anomaly detection method and system capable of detecting anomalies in early stages with high sensitivity is offered.

### Solution to Problem

To achieve the above-described object, the present invention provides a method of representing the state of equipment, the method being applied to the output signals from multidimensional sensors attached to the equipment. Almost normal learning data is prepared, based on case-based reasoning detection of an anomaly by multivariate analysis. The degree of deviation from them is represented by the distance from observational data to the learning data and by temporal trajectories of motion of the observational data and the learning data.

In particular, (1) (nearly) normal learning data is created. (2) An anomaly measurement of observational data is calculated using a subspace classifier or other method. (3) The trajectories of motion of observational data and learning data are evaluated and errors are calculated by a linear prediction method or other method. Learning data is selected for each observation or a piece, block, or set of learning data is selected at a time. (4) The state of the equipment is represented by anomaly measurements and/or the trajectories of motion. (5) An anomaly is judged. (6) The type of the anomaly is identified. (7) The time at which the anomaly occurred is estimated.

It is assumed that the learning data is modeled with a subspace classifier or other method for the case-based reasoning anomaly detection and that candidate anomalies are detected based on the distance relationship between the observational data and the subspace. The trajectories of motion are based on the modeling relying on a linear prediction method.

Furthermore, for each set of observational data, k data sets having the highest degrees of similarity are found from data sets included in learning data, thus creating subspaces. The k is not a fixed value but rather a value selected appropriately depending on each set of observational data. For this purpose, sets of learning data lying at distances within a given range from the observational data are selected. The number of sets of learning data may be successively increased from a minimum number to a selected number, and sets of learning data giving a minimum projection distance may be selected.

As the form of services to clients, the method of detecting anomalies is realized as a program, which in turn is offered to the clients by online services or by the use of media.

### Advantagenous Effects of Invention

According to the present invention, it is possible to clearly check temporal trajectories of observational data visually. This greatly improves the explainability of the anomaly. In addition, the visibility of the trajectories of data sets selected from prepared sets of data in step with observational data is improved. The state of equipment can be represented more precisely. Consequently, even feeble anomalies or abnormalities in the equipment can be detected in early stages.

In consequence, anomalies or abnormalities in various facilities and parts such as water turbines in water power plants, nuclear reactors in atomic power plants, wind turbines in wind power plants, engines in aircraft and heavy-duty vehicles, railway vehicles and rails, escalators, elevators, and even levels of their tools and parts (such as deterioration and lifetime of installed batteries), as well as in equipment such as gas turbines and vapor turbines, can be discovered early with high accuracy.

Other objects, features, and advantages of the present invention will become apparent from the description of embodiments of the invention given below in relation to the accompanying drawings.

### BRIEF DESCRIPTION OF DRAWINGS

FIG. 1 is one example of equipment, multidimensional time series signal, and event signal to which an anomaly detection system of the present invention is applied.

FIG. 2 is one example of multidimensional time series signal.

FIG. 3 is a diagram of an anomaly detection system of the present invention.

FIG. 4 is an explanatory view of a case-based reasoning anomaly detection method using plural identification devices.

FIG. 5A is an explanatory view of a subspace classifier being one example of identification device.

FIG. 5B is another explanatory view of a subspace classifier being one example of identification device.

FIG. 6A is a diagram illustrating the manner in which learning data is selected by a subspace classifier.

FIG. 6B is another diagram illustrating the manner in which learning data is selected by a subspace classifier.

FIG. 7 is an explanatory view of feature conversion.

FIG. 8 is an explanatory view of anomaly measurements calculated by a subspace classifier.

FIG. 9 is a diagram illustrating the trajectory of a residual vector calculated by a subspace classifier.

FIG. 10 is a diagram illustrating residual component signals of a residual vector calculated by a subspace classifier.

FIG. 11 is a diagram illustrating the trajectory of a residual vector calculated by a subspace classifier when plural anomalies or abnormalities have occurred.

FIG. 12 is an example showing anomaly detection relying on a subspace classifier and errors in a linear prediction method for observational data.

FIG. 13 is a general explanatory view of a linear prediction method.

FIG. 14 is an example in which a residual norm relying on a subspace classifier and a residual norm obtained by a linear prediction method are shown.

FIG. 15 is another example in which a residual norm relying on a subspace classifier and a residual norm relying on a linear prediction method are shown.

FIG. 16 shows a distribution of linear prediction coefficients relative to observational data or learning data.

FIG. 17A illustrates a temporally elapsed distribution of observational data.

FIG. 17B illustrates coefficients of a linear prediction method relative to observational data and learning data.

FIG. 18 is a diagram of the surroundings of a processor that implements the present invention.

FIG. 19A is a diagram showing the whole configuration of the present invention.

FIG. 19B is another diagram showing the whole configuration of the present invention.

FIG. 20 is a chart illustrating the flow of operations of the present invention.

FIG. 21 is a chart illustrating the network relationship of sensor signals.

FIG. 22 is a diagram showing the configurations of anomaly detection and causal diagnosis according to the present invention.

FIG. 23 is a diagram showing one example of component information according to the present invention.

FIG. 24 is a diagram showing an anomaly detection and diagnosis system mainly relying on remote monitoring of the present invention.

FIG. 25A is a diagram showing details of maintenance history information of the present invention.

FIG. 25B is a diagram showing association of maintenance history information of the present invention.

FIG. 26A is a view illustrating the trajectory of the starting point of a residual vector.

FIG. 26B is another view illustrating the trajectory of the starting point of a residual vector.

FIG. 26C is a further view illustrating the trajectory of the starting point of a residual vector.

FIG. 26D is an additional view illustrating the trajectory of the starting point of a residual vector.

### DESCRIPTION OF EMBODIMENTS

Embodiments of the present invention are hereinafter described with reference to the drawings.

### Embodiments

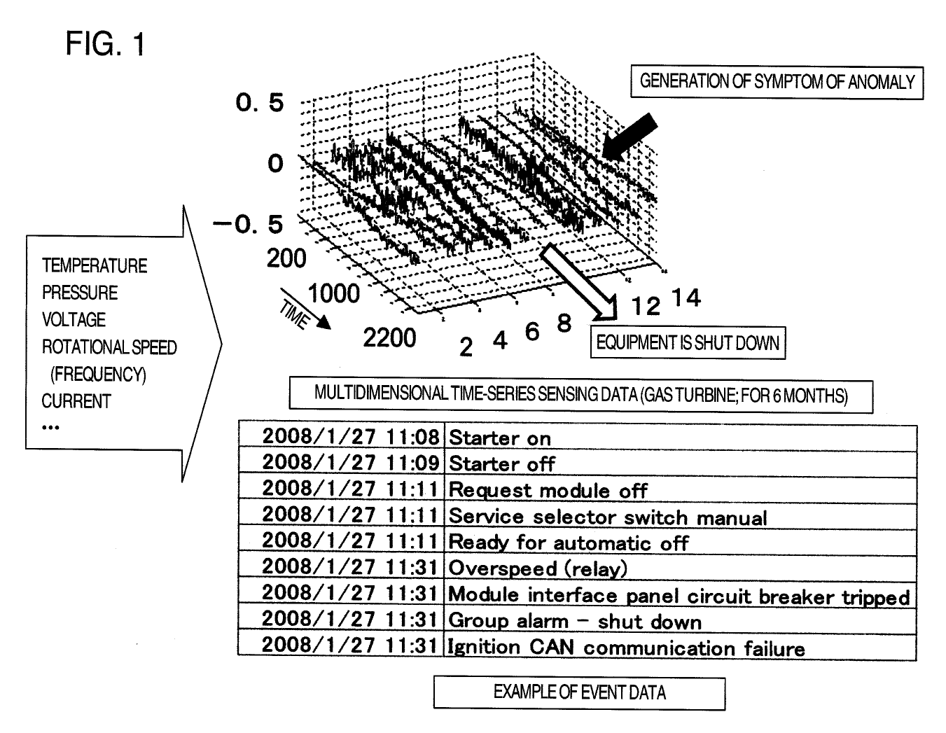

FIG. 1 is one example of equipment, sensor signal, and event signal to which an anomaly detection system of the present invention is applied. There are many types of sensor signals, from tens to tens of thousands. The type of the sensor signal is determined depending on the scale of the equipment and on damage to the society when the equipment is at fault.

The subject is a multidimensional time-series sensor signal. It is a generated voltage, the temperature of exhaust gas, the temperature of cooling water, the pressure of cooling water, the running time, or the like. The installation environment or the like is also monitored. The sampling timing of the sensor similarly varies greatly, for example, from tens of ms to tens of seconds. The event signal consists of the state of operation of the equipment, information about a fault, maintenance information, or the like.

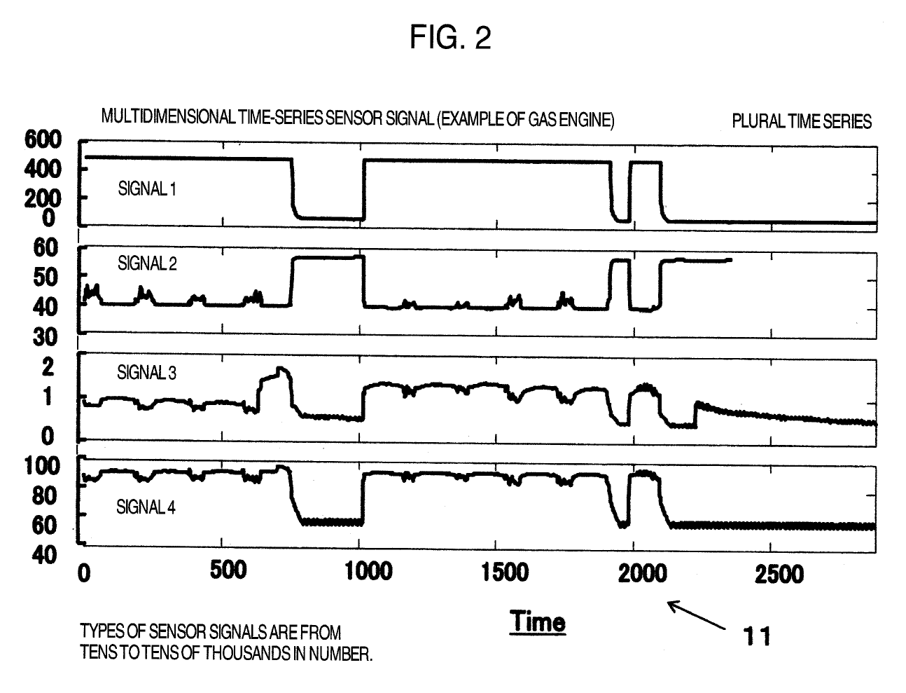

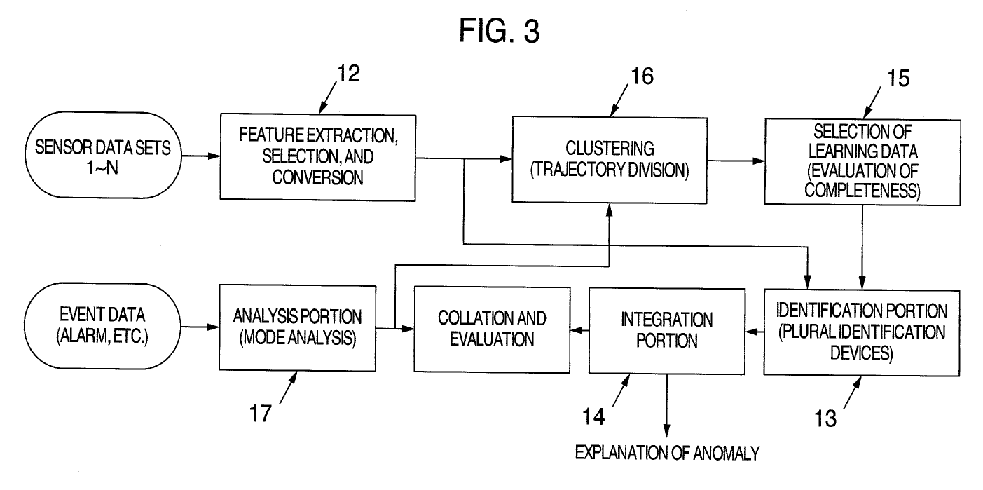

FIG. 2 shows sensor signals, and in which time is arranged on the horizontal axis. FIG. 3 shows a method of detecting anomalies or abnormalities based on a case-based reasoning approach. It consists of feature extraction, selection, and conversion 12, clustering 16, and learning data selection 15. An identification portion 13 extracts, by multivariate analysis, those observational sensor data sets which are regarded as outliers as viewed from normal data sets from multidimensional time-series sensor signals.

In the clustering 16, sensor data are classified into some categories according to mode and depending on the state of operation or the like. Besides the sensor data, event data (on the state of operation including ON/OFF control of equipment, alarm information (various alarms), regular inspection and adjustment of the equipment, and so on) may be used, and learning data may be selected or an anomaly diagnosis may be done based on the results of the analysis. The event data may be input to the clustering 16, and data can be divided into some categories according to mode and based on the event data.

In an analysis portion 17, event data are analyzed and interpreted. Furthermore, in the identification portion 13, identification is performed using plural identification devices. The results are combined into one in an integration portion 14, thus achieving robuster anomaly detection. A message giving an explanation of an anomaly is output in the integration portion 14.

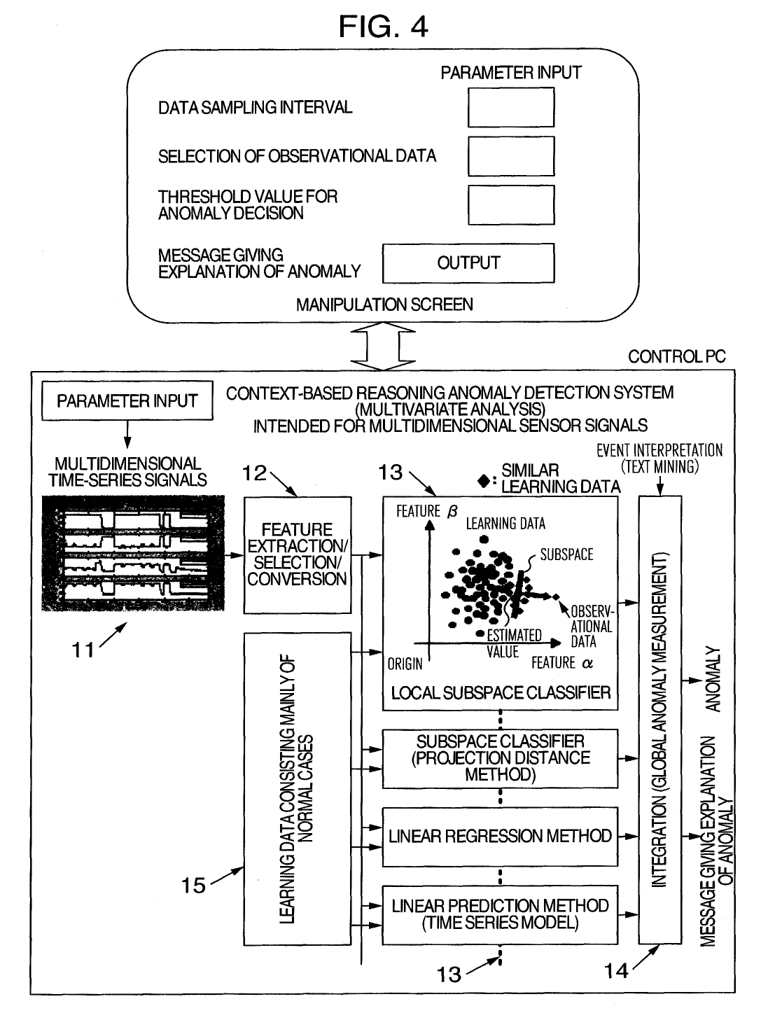

A case-based reasoning anomaly detection method is illustrated in FIG. 4. In this anomaly detection, indicated by 11 is a multidimensional time-series signal acquisition portion. Indicated by 12 is a feature extraction/selection/conversion portion. Indicated by 13 is the identification device. Indicated by 14 is the integration (global anomaly measurement). Indicated by 15 is the learning data mainly consisting of normal cases.

The multidimensional time-series signal entered from the multidimensional time-series signal acquisition portion 11 is reduced in dimension by the feature extraction/selection/conversion portion 12 and identified by the plural identification devices 13. The global anomaly measurement is judged by the integration (global anomaly measurement) 14. The learning data 15 consisting mainly of normal cases are also identified by the plural identification devices 13 and used to judge the global anomaly measurement. Some of the learning data 15 themselves consisting mainly of normal cases are selected, stored, and updated. Thus, it is attempted to improve the accuracy.

FIG. 4 also shows a control PC manipulated by a user to enter parameters. The parameters entered by the user include data sampling interval, selection of observational data, and a threshold value used for a decision regarding an anomaly. For example, the data sampling interval indicates intervals in seconds at which data is acquired.

The selection of observational data is used to indicate which of sensor signals is mainly used. The threshold value for a decision regarding an anomaly is a threshold value for binarizing each calculated value representing anomalousness, i.e., indicating a deviation from a model, an outlier, a deviance, an anomaly measurement, or the like.

Some identification devices (h1, h2, and so forth) are prepared for the plural identification devices 13 shown in FIG. 4, and the integration 14 can choose by majority decision. That is, ensemble learning using different groups of identification devices (h1, h2, and so forth) can be applied. For example, the first identification device is a projection distance method, the second identification device is a local subspace classifier, and the third identification device is a linear regression method. If based on case-based reasoning data, any arbitrary identification devices can be applied.

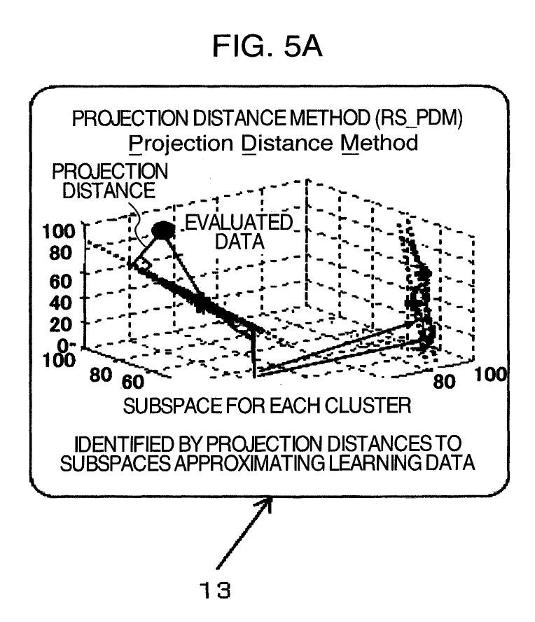

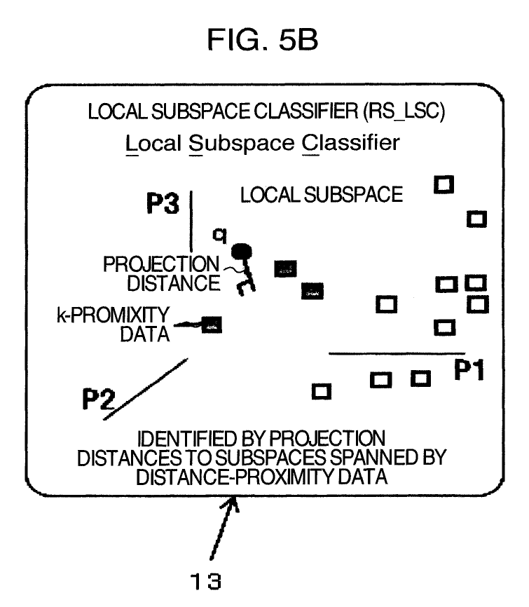

FIGS. 5A and 5B show examples of an identification method in the identification devices 13. FIG. 5A shows a projection distance method, which is used to find a deviation from a model. Generally, the deviation is found by decomposing an autocorrelation matrix of data sets of different classes (categories) into eigenvalues and using the eigenvalues as a base. Eigenvectors corresponding to higher significant eigenvalues having larger values are used.

If an unknown pattern q (the newest observation pattern) is applied, the length of an orthogonal projection onto a subspace or the projection distance to the subspace is found. For a multidimensional time-series signal, a normal portion is handled in a fundamental manner. Therefore, the distance from the unknown pattern q (the newest observation pattern) to a normal class is found and taken as a deviation (residual). If the deviation is great, it is determined that it is an outlier.

In this subspace classifier, if a slight amount of abnormal values is mixed, its effect is mitigated when a dimension reduction is performed and a subspace is achieved. This is the merit of application of a subspace classifier. Taking account of the operational pattern of equipment, with respect to normal classes, data are previously classified into plural classes. Here, event information may be used or the classification may be carried out by the clustering 16 of FIG. 3.

In a projection distance method, the center of gravity of the classes is taken as the origin. Eigenvectors obtained by applying a KL expansion to the covariance matrices of the classes are used as a base. Various subspace classifiers have been devised. If the subspace classifier has a distance scale, the degree of deviation can be computed. In the case of densities, too, their degrees of deviation can be judged depending on their magnitudes. In a projection distance method, the length of the orthogonal projection is found and so gives a scale of degree of similarity.

In this way, it follows that distances and degrees of similarity are calculated in subspaces and that degrees of outliers are evaluated. In a subspace classifier such as a projection distance method, there are provided identification devices based on distances. Therefore, as a learning method adopted in a case where anomaly data or abnormality data can be used, metric learning that learns vector quantization for updating a dictionary pattern or a distance function can be employed.

FIG. 5B shows another example of identification method in the identification devices 13. This is a method known as a local subspace classifier. Multidimensional time-series signals which are k in number and close to an unknown pattern q (the newest observation pattern) are found. A linear manifold in which the nearest pattern of classes gives the origin is created. Unknown patterns are classified into classes at a minimum projection distance to the linear manifold. A local subspace classifier is also a type of subspace classifier. k is a parameter. In anomaly detection, the distance from the unknown pattern q (the newest observation pattern) to the normal class is found and taken as a deviation (residual).

In this method, a point which is in a subspace formed, for example, using k multidimensional time-series signals and to which the unknown pattern q (newest observation pattern) has been orthogonally projected can also be calculated as an estimated value.

Furthermore, an estimated value of each signal can also be computed by rearranging the k multidimensional time-series signals in order from the signal closest to the unknown pattern q (newest observation pattern) and weighting the signals in inverse proportion to the distance. Estimated values can be similarly calculated using a projection distance method or other method.

Usually, the parameter k is set to one type. If processing is performed while varying the parameter k between some values, it follows that treated data will be selected according to the degree of similarity. An overall decision is made based on the results. This yields more advantageous effects.

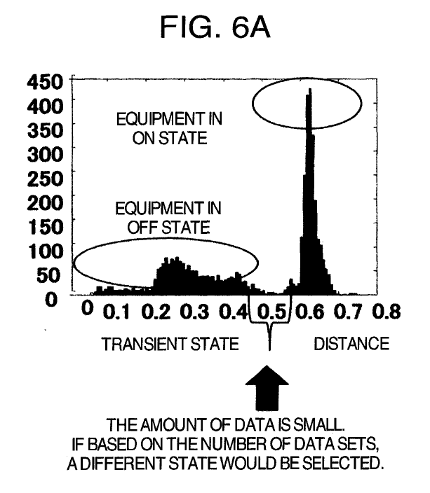

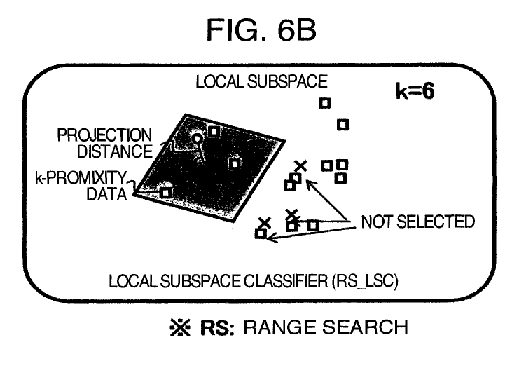

Further, as shown in FIG. 6B illustrating selection of learning data by a subspace classifier, learning data sets at those distances from observational data which are within a given range are selected such that the value of k is made to assume an appropriate value for each observational data set. Furthermore, the number of learning data sets may be increased in succession from a minimum number to a selected number, and a data set giving a minimum projection distance may be selected.

This can also be applied to a projection distance method. A specific procedure is as follows.

1. The distances between observational data sets and learning data sets are calculated, and they are rearranged in ascending order.

2. Learning data sets which are at distances d<th and whose number is equal to or less than k are selected.

3. Projection distances are calculated within a range from j=1 to k, and a minimum value is output.

Here, the threshold value th is experimentally determined from the distribution of the frequencies of distances. A distribution shown in FIG. 6A illustrating selection of learning data by a subspace classifier represents a distribution of the frequencies of distances of learning data sets as viewed from observational data. In this example, the distribution of the frequencies of the distances of learning data assumes two peaks according to ON and OFF of the equipment. The valley between the two peaks indicates a transient phase from ON to OFF of the equipment, or conversely, from OFF to ON.

This thought is a concept known as a range search. It is considered that this is applied to selection of learning data. The concept of selection of learning data in the form of this range search can also be applied to the method of SmartSignal. In a local subspace classifier, even if a slight amount of abnormal values is mixed, its effect is mitigated greatly at the instant when the local subspace is formed.

In identification known as LAC (Local Average Classifier) method, the center of gravity of k-vicinity data is defined as a local subspace in an unillustrated manner. The distance from the unknown pattern q (newest observation pattern) to the center of gravity is found and taken as a deviation (residual).

The examples shown in FIG. 5 of identification method in the identification devices 13 are offered as programs. If each sample is considered simply as a problem of one class classification, identification devices such as 1-class support vector machine can be applied. In this case, a technique of making a kernel such as radial basis function for mapping onto a higher-order space can be used.

In a 1-class support vector machine, the side closer to the origin is an outlier, i.e., becomes abnormal. The support vector machine can cope with the situation even if the dimensionality of the amount of features is great. However, there is the disadvantage that the amount of computation is become exorbitant if the number of learning data sets is increased.

Therefore, a method such as “One Class Classifier based on Proximity between Patterns; IS-2-10 Takekazu Kato, Mami Noguchi, Toshikazu Wada (Wakayama University), Kaoru Sakai, Shunji Maeda (Hitachi)” published in MIRU2007 (Symposium on Recognition and Understanding of Images, Meeting on Image Recognition and Understanding 2007) can also be applied. In this case, if the number of learning data sets or items is increased, there is the advantage that the amount of calculation is prevented from becoming exorbitant.

In this way, a complex state can be decomposed by representing multidimensional time-series signals with a low-dimensional model. Since they can be represented by a simple model, there is the advantage that it is easy to understand the phenomenon. Furthermore, since a model is set, it is not necessary to prepare a full set of data as in the method of SmartSignal.

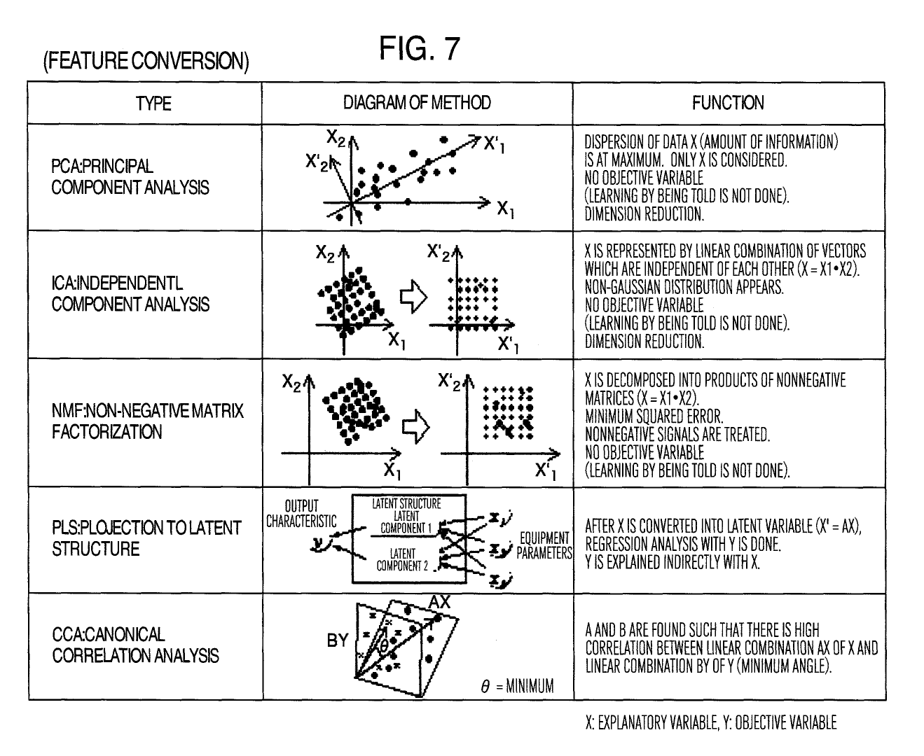

FIG. 7 shows an example of feature conversion for reducing the dimensionality of multidimensional time-series signals used in FIG. 3. Besides principal component analysis, some techniques such as independent component analysis, nonnegative matrix factorization, Projection to Latent Structure, and canonical correlation analysis can be applied. A method diagram and functions are both shown in FIG. 7.

Principal component analysis is known as PCA, linearly converts multidimensional time-series signals of M dimensions into r-dimensional, multidimensional time-series signals of r dimensions, and creates an axis along which a maximum amount of variations is produced. A KL transform may also be used. The dimension number r is determined based on a value, known as an accumulative contribution ratio, which in turn is obtained by finding eigenvalues by principal component analysis, arranging the eigenvalues in descending order, and dividing the sum of all the eigenvalues by a sum of larger ones of the eigenvalues.

Independent component analysis is known as ICA, and is a technique that is effective in manifesting a non-Gaussian distribution. Nonnegative matrix factorization is known as NMF and decomposes sensors signals given in the form of a matrix into nonnegative components.

What are described as no learning being told are transform techniques which are effective where there are only a few anomalous cases exploited as in the present embodiment. Here, an example of linear transformation is shown. Nonlinear transformation can also be applied.

The aforementioned feature transformations, including canonicalization in which normalization is done with a standard deviation, are carried out simultaneously while arraying learning data and observational data. Thus, learning data and observational data can be dealt with on the same basis.

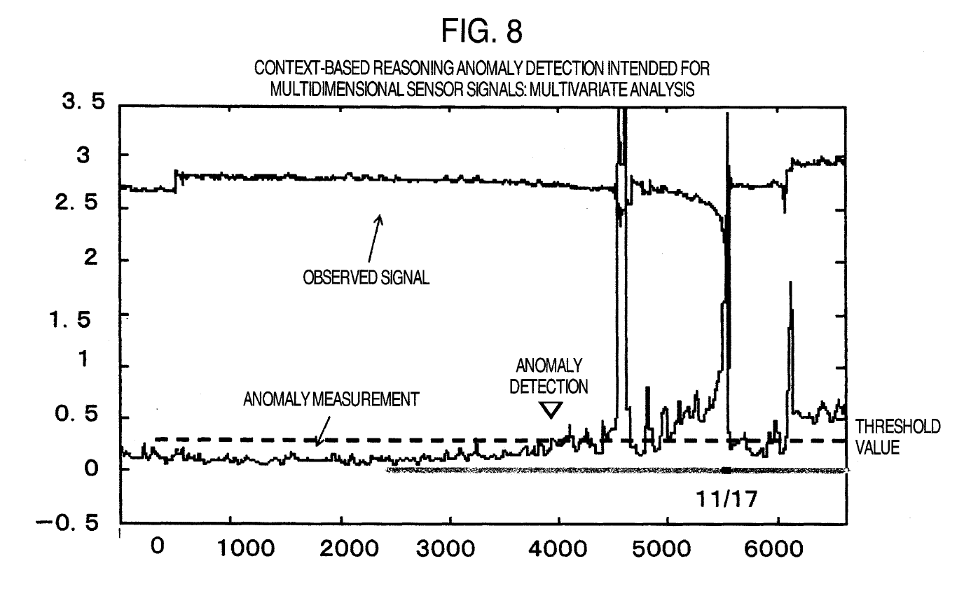

FIG. 8 shows one example of result of a case-based reasoning anomaly detection. The upper side of the figure indicates one of observed signals, while the lower side indicates an anomaly measurement calculated from multidimensional time-series sensor signals by multivariate analysis. In this example, the observed signal decreased gradually and the equipment was shut down.

If the anomaly measurement reaches or exceeds a predetermined threshold value or exceeds it a preset number of times or more, it is determined that there is an anomaly or abnormality. In this example, a symptom of the anomaly can be detected before the shutdown of the equipment, and appropriate countermeasure can be carried out.

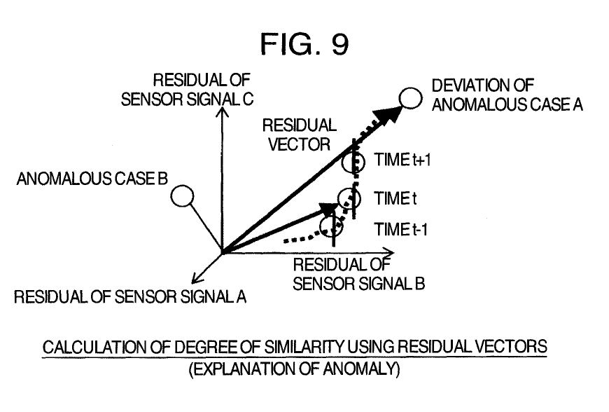

FIG. 9 is a diagram illustrating a technique for detecting a symptom of generation of an anomaly using a residual pattern. FIG. 9 shows the technique of calculating degrees of similarity in the residual pattern. In FIG. 9, the normal center of gravity of observational data sets is found by a local subspace classifier, and the deviations of sensor signals A, B, and C from the normal center of gravity at each instant of time are represented as trajectories within spaces.

In FIG. 9, a residual sequence of observational data going through instants t−1, t, and t+1 is indicated by an arrowed dotted line. Degrees of similarity of the observational data and anomalous or abnormal cases can be estimated by calculating the inner product (A•B) of their deviations. Furthermore, the degrees of similarity can be estimated using angle θ by dividing the inner product (A•B) by a magnitude (norm). An anomaly forecasted to occur is estimated by finding degrees of similarity of observational data sets to a residual pattern and using their trajectories.

In particular, a deviation of anomalous case A, a deviation of anomalous case B, and a deviation of an anomalous case C are shown in FIG. 9. Observation of the deviation sequence pattern of the observational data indicated by the arrowed dotted line shows that a situation close to the anomalous case B takes place at instant t but generation of the anomalous case A can be forecast from the trajectory rather than the anomalous case B.

In order to forecast an anomalous case, a database is built from data about the trajectories of the deviation (residual) time sequences occurring until the generation of anomalous cases. A symptom of generation of an anomalous case can be detected by calculating the degree of similarity between the deviation (residual) time series pattern of observational data and the time series pattern of the trajectory data accumulated in the trajectory database.

If such a trajectory is presented to the user by GUI (graphical user interface), the manner in which an anomaly has occurred can be visually represented. Also, this can be easily reflected in a countermeasure or the like.

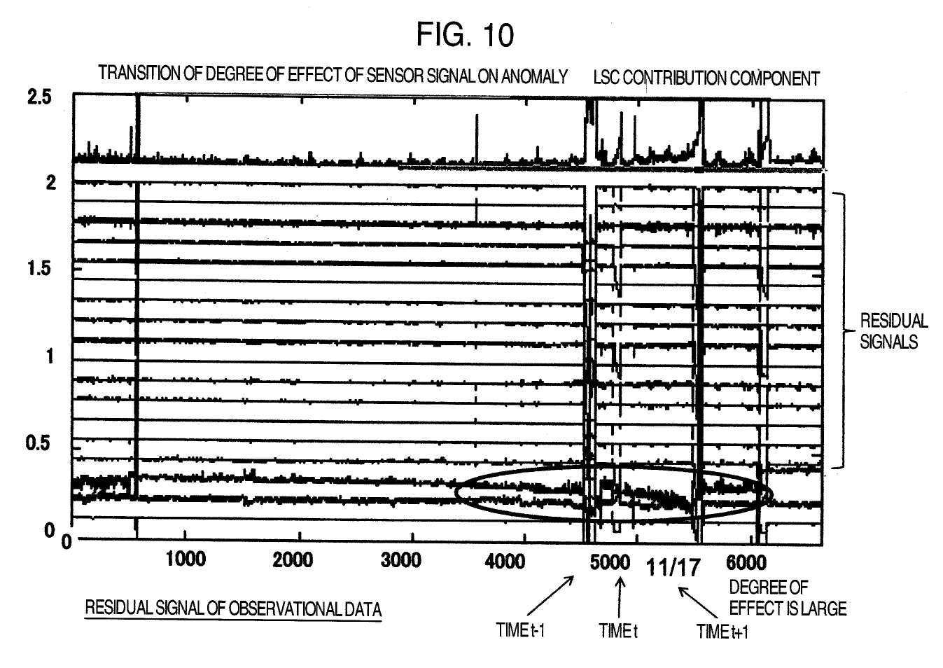

FIG. 10 shows temporal transitions of deviation (residual) signals of plural observational data sets corresponding to the sensor signals A, B, C, and so on of FIG. 9. In FIG. 10, such an anomalous circumstance that the jacket water pressure drops at instant 11/17, for example, occurs. Residual signals of observational data sets are detected at instants t−1, t, and t+1. The degrees of similarity of the time series pattern of trajectory data accumulated in the trajectory database are calculated, and a symptom of generation of a certain anomaly can be detected. Especially, it is possible to identify what sensor is exhibiting an anomalous phenomenon. Data at the top of FIG. 10 are anomaly measurements.

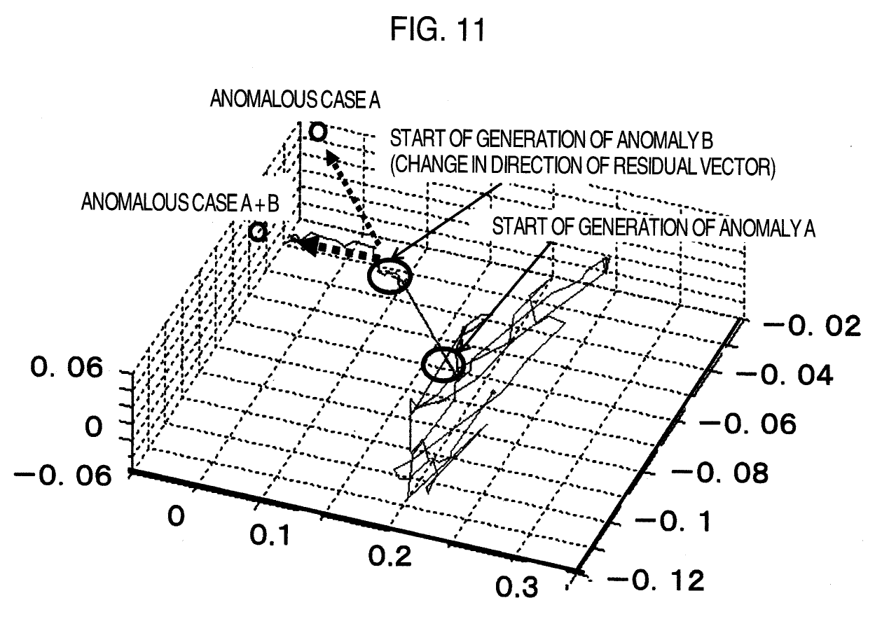

FIG. 11 shows a case of anomalous instances of a composite phenomenon. The case shown in the figure is that anomalous case A (for example, abnormality in exhaust temperature) first occurred and that anomalous case B (for example, abnormality in generated electric power) occurred 4 days later.

The abnormalities or anomalies are of such a type that they increase gradually.

The condition is normal prior to the generation of the anomalous case A but data is varying along a certain plane. A deviation starts from the instant when the anomalous case A occurred in a direction perpendicular to the plane.

If only the overall residual is traced while neglecting the temporal development, it is difficult to understand anomalous phenomena. However, if the temporal development of the residual vector can be traced, the phenomenon can be understood quite easily. Theoretically, a symptom of generation of an anomaly of a composite phenomenon can be detected by adding up vectors of individual events of the composite phenomenon. It can be seen that a residual vector precisely represents an anomaly. If the trajectories of past anomalous cases A, B, and so on are already known and present in a database, the types of the anomalies can be identified (or diagnosed) by doing collation against them.

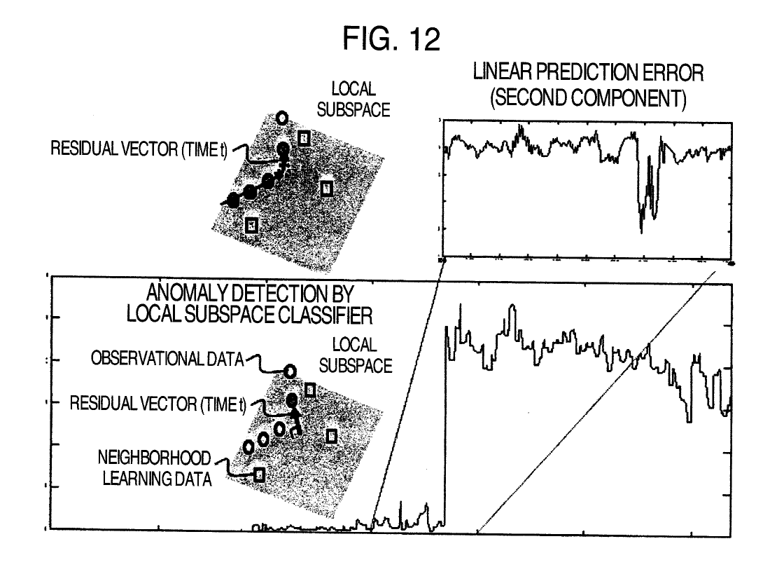

FIG. 12 shows one example of representation format of temporal trajectories of motions of observational data and learning data. The resultant of a residual vector v_lsc relying on a local subspace classifier and a linear prediction error vector v_lpc is noticed. It can be seen that the residual vector v_lsc relying on a local subspace classifier increased in steps from some instant of time and that an anomaly occurred.

On the other hand, when an anomaly occurred, the linear prediction error vector v_lpc (whose second component is shown in the figure) was observed to vary greatly. These data make it possible to visually represent where observational data is present relative to a normal boundary (in the figure, deviating from normal), in what direction is the vector moving (leaves in a stepwise manner in the figure), whether the vector is moving away from the normal boundary (this is the case in the figure), and whether the vector has returned to the normal boundary.

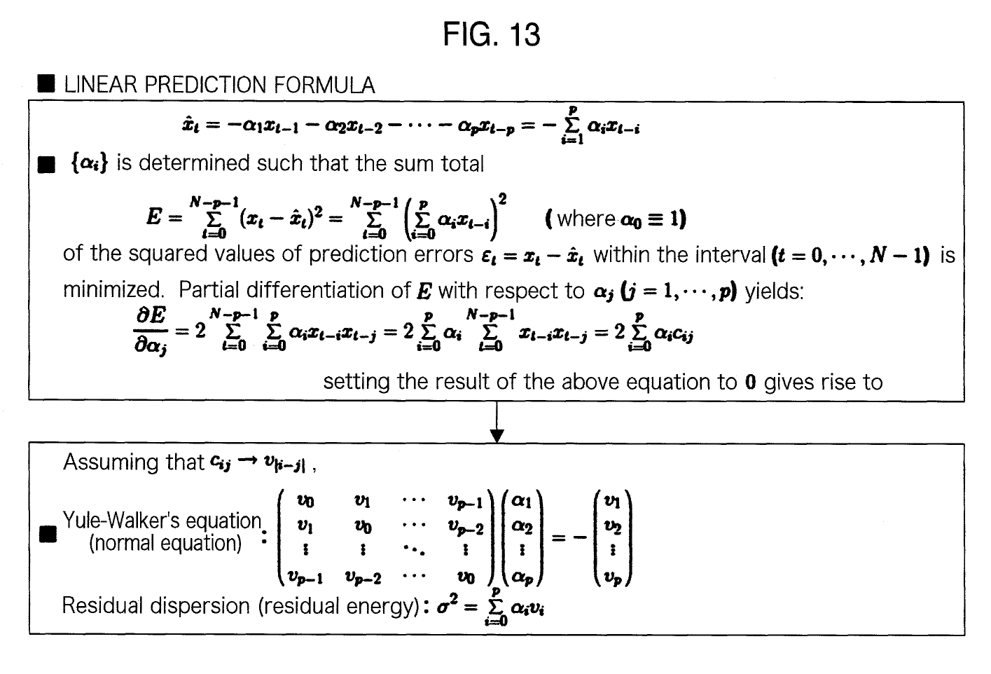

FIG. 13 illustrates a fundamental formula for a linear prediction method. Although detailed description is omitted, using past data and data xt-j observed at instant t-j (j=1 to p), data xt at the next instant t is predicted on the basis of minimum squared error (by solving a Yule-Walker's equation). A coefficient a representing a linear combination of past data is important. It follows that the past data is modeled owing to this coefficient. Although the data is represented by a linear combination, a high-order representation is also possible. That is, a linear combination regarding xt-j may be represented as a linear combination of the nth powers of xt-j.

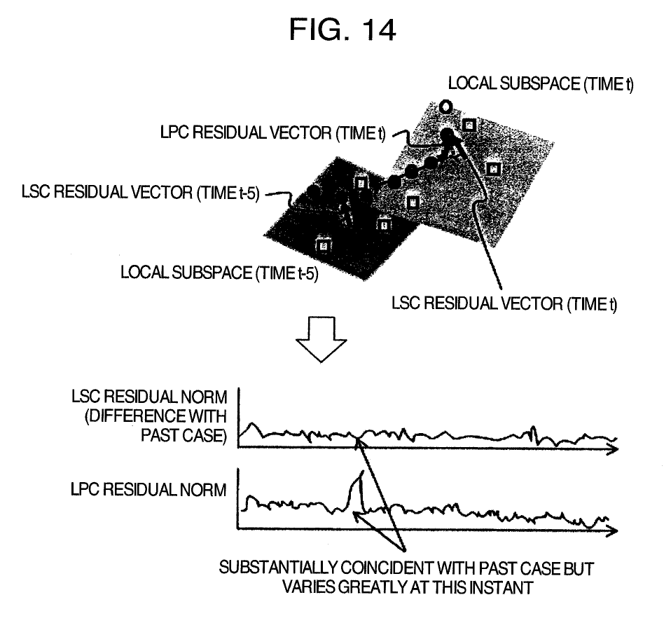

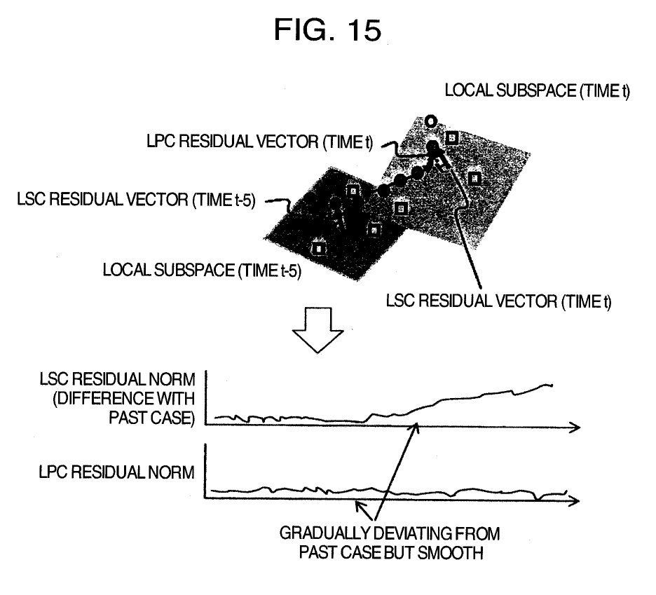

FIGS. 14 and 15 show examples of residual norm using a local subspace classifier (LSC) and residual norm (error norm) of linear prediction method or linear predictive coding (LPC). In FIG. 14, LSC residual (anomaly measurement) is small and the LPC residual (prediction error) is large. Therefore, it is considered that a transient phase (learning data is prepared) to a different state or long-term variations exceeding the range covered by the learning data are represented.

In FIG. 15, the LSC residual (anomaly measurement) increases gradually, and the LPC residual (prediction error) is small. Therefore, it is considered that sensor drift not experienced in past cases is represented.

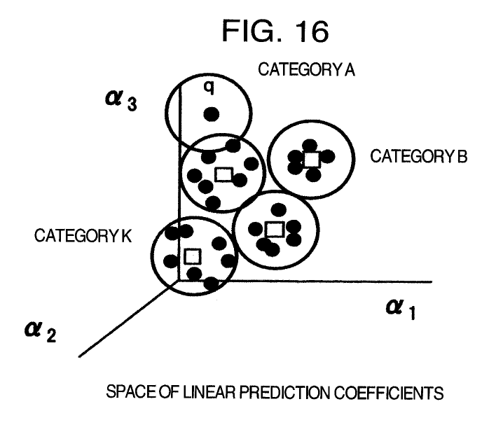

In FIG. 16, values of the coefficient α of the linear predictive coding (LPC) of observed sensing data are plotted on the axes, thus showing their distribution. Here, three upper principal components having the highest contribution ratios are displayed by principal component analysis. In a space defined by axes of the upper α values, the behaviors of the observed sensing data can be classified into categories because of the distribution of the data (in the figure, the behaviors can be classified into categories A, B, K, and so on).

If these coefficients are also stored as learning data, the current state can be classified into categorizes from the categories of the coefficients and can be used for a decision regarding an anomaly. If the types of anomalous cases generated in the past are stored, an anomaly diagnosis can also be made by collation with the a value distribution produced when an anomaly takes place. For these detection and diagnosis, a subspace classifier can also be applied to the coefficient α values of the linear predictive coding (LPC).

Furthermore, the coefficients α of the linear predictive coding (LPC) of learning data can be classified into categories. Here, for learning data sets selected by a local subspace classifier or other method, the coefficient α of the linear predictive coding (LPC) is found. Thus, the behaviors of learning data can be categorized. This permits evaluation of the quality of learning data.

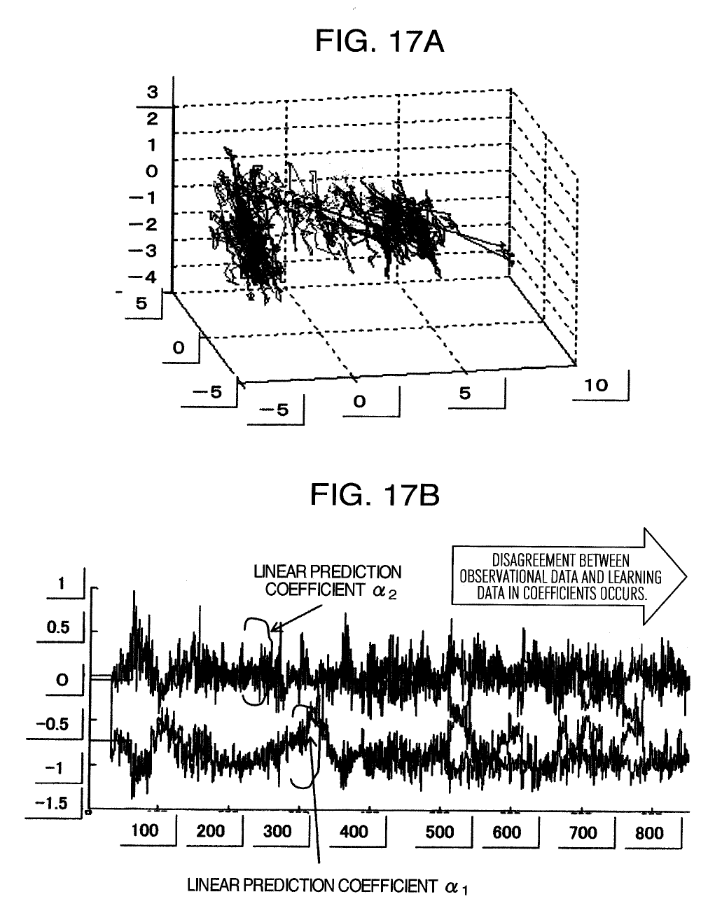

FIGS. 17A and 17B show the results of investigation of time sequential behavior of the linear prediction coefficients regarding slightly complex data. FIG. 17A shows a distribution of observational data. Three upper principal components having the highest contribution ratios are displayed by principal component analysis. Although it is not easy to see from the figure, there is gradual drift and an anomaly occurs.

FIG. 17B shows two coefficients of temporally close terms out of the linear predictive coefficient α. The lateral axis indicates time. Especially, linear prediction of selected learning data is done, as well as of observational data. It can be seen from this time sequential behavior that the observational data and the learning data are greatly different in predictive coefficients in the latter half and that an anomaly has occurred.

In this instance, if the parameter k of the local subspace classifier is increased, the predictive coefficient α of learning data is unstable. Therefore, it can be concluded that the observational data behaves in a manner not approximated linearly. However, if the parameter k of the local subspace classifier is small, the predictive coefficient α of learning data is unstable and so it can be seen that the density of the learning data is low (there are only a few past instances).

It is considered that learning data has insufficient capabilities of coping with temporal variations. It is also considered that a shift to other learning data (e.g., learning data obtained last year, learning data obtained when the same running pattern occurs, and learning data about the same season) should be made. In this example, two coefficients of temporally close terms are selected out of the linear predictive coefficients α. Coefficients that are temporally close to observational data are prevalent.

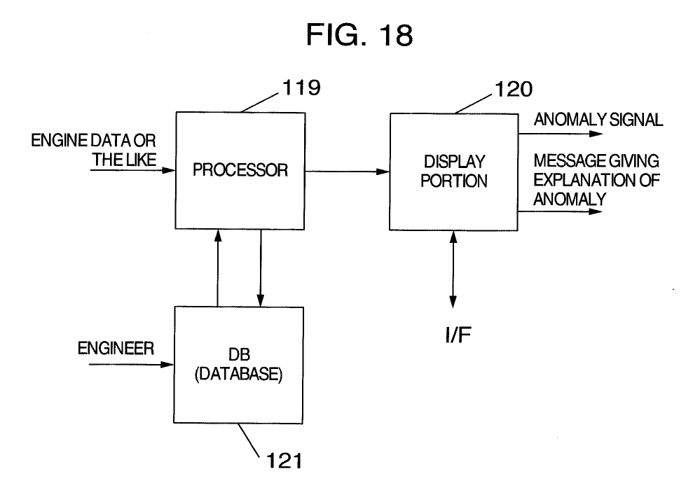

FIG. 18 shows the hardware configuration of an anomaly detection system of the present invention. Data from sensors of an engine or the like to be treated are entered to a processor 119 that carries out an anomaly detection. Missing values are repaired or otherwise processed and stored in a database DB 121. The processor 119 detects an anomaly using the DB data consisting of derived, observed sensor data and learning data. Various displays are provided on a display portion 120, which outputs a message indicating whether there is an anomaly signal and a message giving an explanation of an anomaly as described later. A trend can also be displayed. The results of an interpretation of an event can also be displayed.

Besides the hardware, a program that is loaded into it can be offered to clients by media or online services.

Skilled engineers and others can manipulate the database DB 121. Especially, it can teach and store anomalous cases and countermeasure instances. (1) Learning data (normal), (2) anomaly data, and (3) contents of countermeasures are stored. A sophisticated useful database is built by configuring the database DB in such a way that skilled engineers can modify it. Data are manipulated by automatically moving learning data (individual data sets, the position of the center of gravity, and so on) as an alarm is issued or a part is replaced. Furthermore, acquired data can be automatically added. If anomaly data is present, a technique such as generalized vector quantization can be applied to move data.

Additionally, the trajectories of the past anomalous cases A, B, and so on described in FIG. 11 are stored in the database DB 121 and collated against it to identify (diagnose) the type of the anomaly. In this case, the trajectories are represented as data within an N-dimensional space and stored.

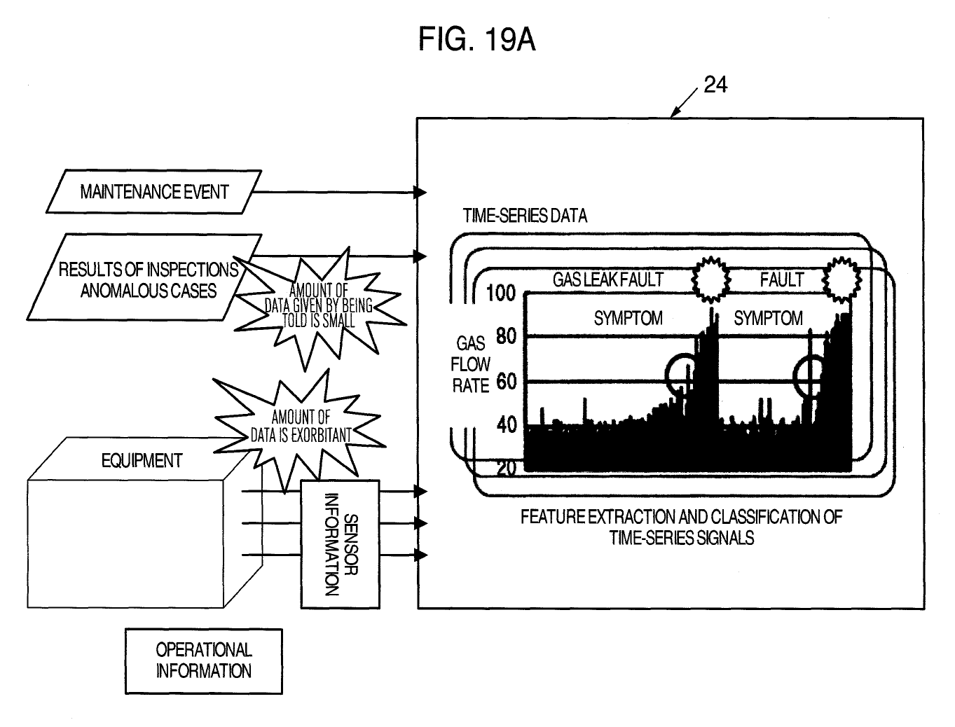

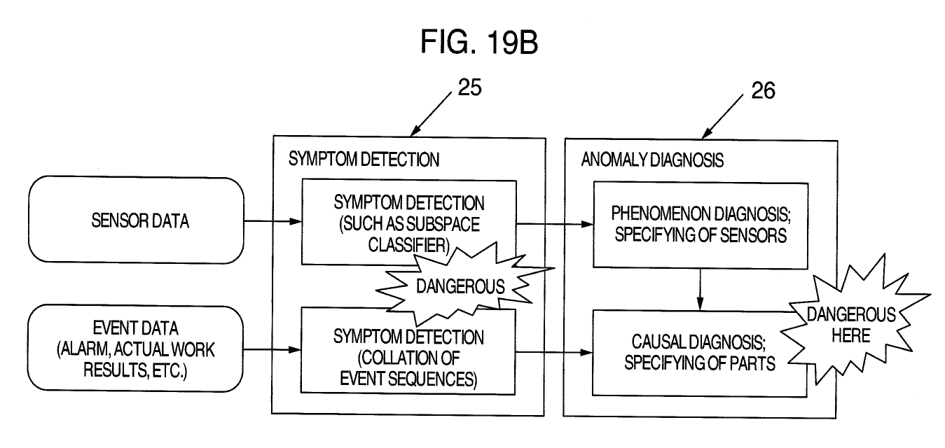

FIGS. 19A and 19B show diagnoses made for and after an anomaly detection. In FIG. 19A, an anomaly is detected from a time series signal coming from equipment by feature extraction/classification 24 of the time series signal. The equipment is not always a unit of equipment. The diagnosis may be intended for plural units of equipment. At the same time, collateral information about maintenance events of pieces of equipment (alarms, actual work results, and so on (i.e., starting and stoppage of the equipment, settings of operating conditions, information about various faults, information about various warnings, information about periodic inspections, operational environment such as installation temperature, accumulative running time, information about replacements of parts, adjustment information, cleaning information, and so forth)) is accepted, and anomalies are detected at high sensitivity.

As shown in FIG. 19B, if it can be discovered as a symptom at an early stage by symptom detection 25, then it is possible to take any countermeasure before a breakdown occurs and the equipment is shut down. The symptom is detected by a subspace classifier or other method. Event sequence collation or the like is added. An overall decision is made as to whether there is a symptom. Based on the symptom, an anomaly diagnosis is made. Candidate faulty parts are identified. It is estimated when the parts will break down and be shut down. Necessary parts are arranged at necessary timing.

The understanding is facilitated if anomaly diagnosis 26 is divided into a phenomenon diagnosis for identifying sensors that might incorporate a symptom and a causal diagnosis for identifying parts that might cause a fault. An anomaly detection portion outputs a signal indicating the presence or absence of an anomaly to an anomaly diagnosis portion. In addition, the detection portion outputs information about a feature amount. The anomaly diagnosis portion conducts a diagnosis based on these pieces of information.

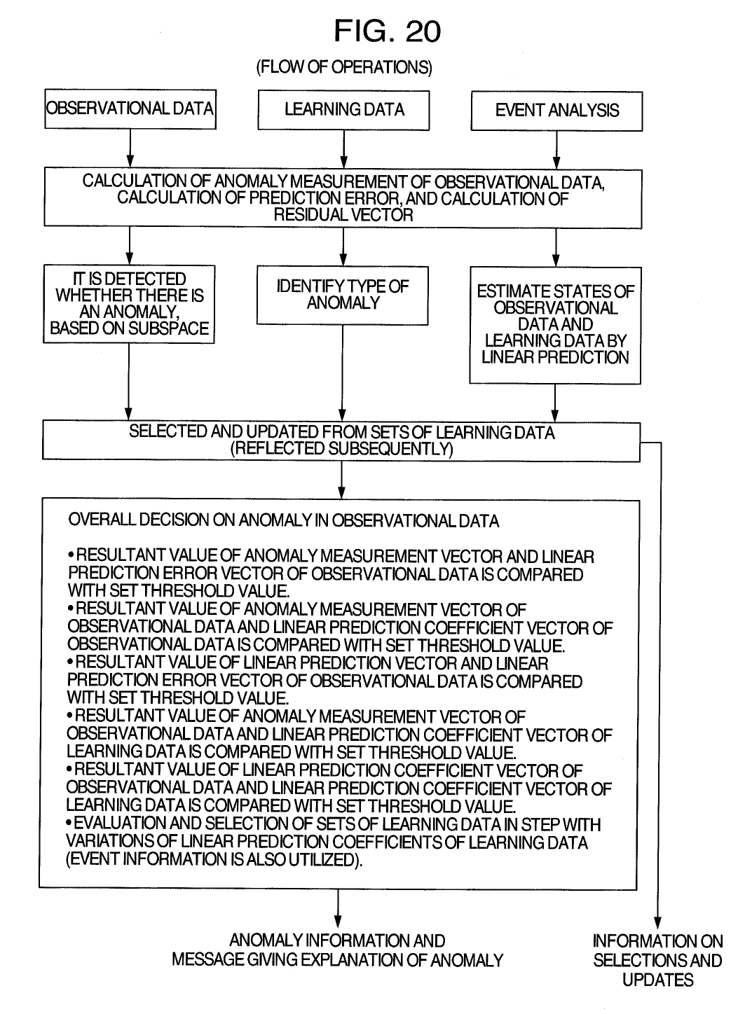

In FIG. 20, a deviance (degree of similarity) between observational data and learning data is first calculated using the observational data, learning data, and the results of an event analysis. Event data (such as alarm information) is used, for example, to select learning data. Then, a decision is made as to whether a candidate anomaly exists, based on the deviance (degree of similarity) between the observational data and the learning data (the threshold value is set from the outside). At the same time, the degree of effect of each candidate anomaly is computed. Here, each observational data set is identified (known as LAC method) using the average of k-proximity data in each class and the distances between the observational data sets. Additionally, the kind of the candidate anomaly is identified.

Then, linear predictions of the observational data and selected learning data sets are made to represent their states. Based on the represented states, learning data sets (e.g., learning data for each season or each running pattern) are selected and updated. Regarding the selected or updated learning data, information indicating the selection or update is output to the outside.

Specifically, according to the category of the linear prediction coefficient as described in FIG. 16, the quality of the learning data is evaluated. Other learning data is selected or an update of learning data is performed. When a linear prediction of learning data is made, if the residual vector increases in length (i.e., when a preset threshold value is exceeded), other learning data may be selected or an update of the learning data may be done in an unillustrated manner.

Finally, based on these pieces of information, a decision is made about an anomaly from candidate anomalies. For example, some of anomaly decision logics are as follows.

1) For each set of observational data, an anomaly measurement vector and a linear predictive error vector are combined, and the resulting value is compared against a preset threshold value.

2) An anomaly measurement vector for each set of observational data and a linear predictive coefficient vector for the set of observational data are combined, and the resulting value is compared against a preset threshold value.

3) A linear predictive coefficient vector and a linear predictive coefficient vector for each set of observation data are combined, and the resulting value is compared against a preset threshold value.

4) An anomaly measurement vector for each set of observational data and a linear predictive coefficient vector for a set of learning data are combined, and the resulting value is compared against a preset threshold value.

5) A linear predictive coefficient vector for a set of observational data and a linear predictive coefficient vector for a set of learning data are combined, and the resulting value is compared against a preset threshold value.

6) Learning data sets are evaluated and selected in an interlocked manner with variation of the linear predictive coefficient for learning data (also exploiting event information).

7) Combinations of the foregoing.

Besides them, a combination of feature selection, a combination of event information, and other combinations are also conceivable. Sensor signals selected also taking account of coefficients indicate that they are strongly associated on occurrence of an anomaly and thus they are useful information. If these pieces of information are collected for each instance, the subject equipment can be modeled.

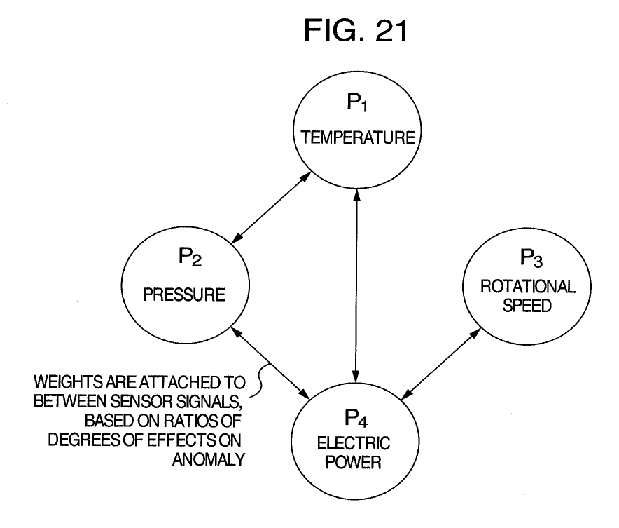

FIG. 21 shows an example in which a network of sensor signals is created from obtained information about the degree of effect of each sensor signal on an anomaly. Regarding sensor signals about fundamental temperature, pressure, electric power, and so on, weights can be attached to between the sensor signals based on the ratios of the degrees of the effects on the anomaly.

If such a relevance network is built, connectivity, collocation, correlation, and so on between signals for which the designer is not intended can be explicitly represented. This is useful also when an anomaly is diagnosed. A network can be created using various kinds of scales such as the degree of effect of each sensor signal on an anomaly, correlation, degree of similarity, distance, causality, and phase lead/lag.

<Model of Subject Equipment; Network of Selected Sensor Signals>

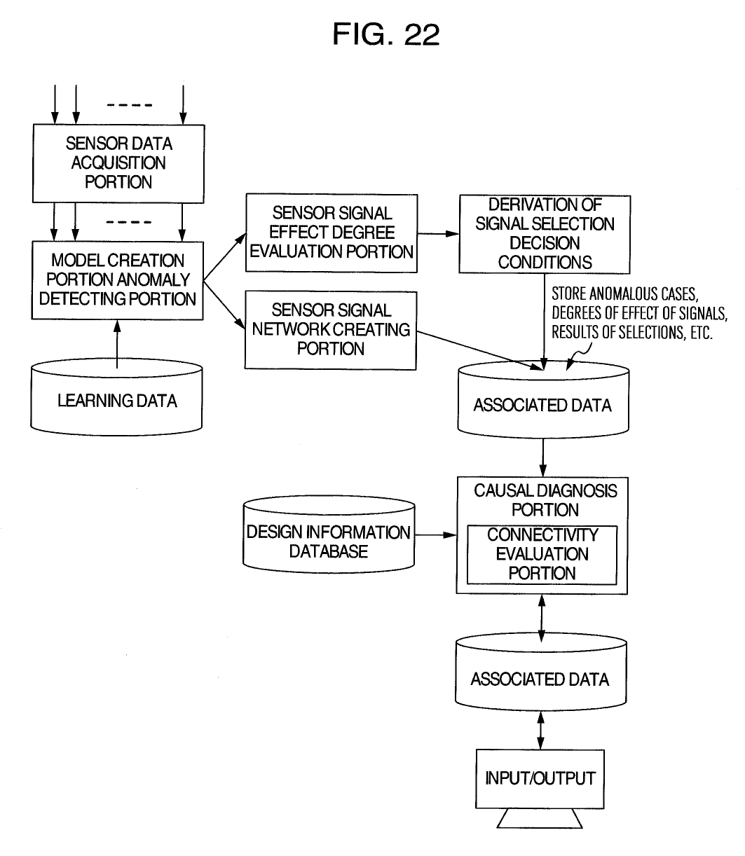

FIG. 22 shows configurations of portions of anomaly detection and causal diagnosis. What is shown in FIG. 22 consists of a sensor data acquisition portion for acquiring data from plural sensors, learning data consisting substantially of normal data, a model creating portion for modeling the learning data, an anomaly detection portion for detecting whether observational data has an anomaly depending on the degree of similarly between the observational data and the modeled learning data, a sensor signal effect degree evaluating portion for evaluating the degree of effect of each signal, a sensor signal network creating portion for creating a network diagram indicative of the association between the sensor signals, an association database including anomalous cases, degrees of effects of the sensor signals, and the results of selections, a design information database consisting of design information about the equipment, a causal diagnosis portion, an association database for storing the results of diagnoses, and input/output.

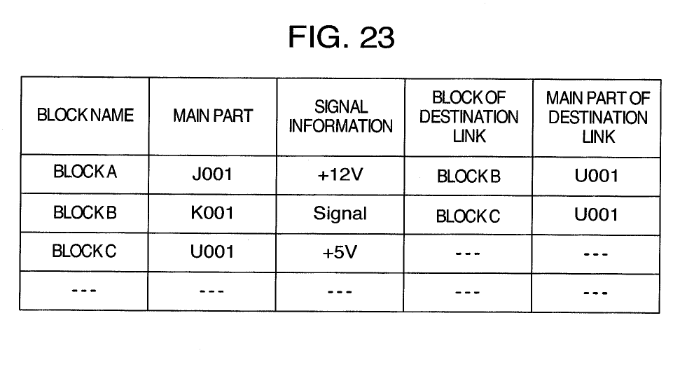

The design information database includes information other than the design information. Taking an engine as an example, the database contains model year, model, components shown in FIG. 23, a Bill of Materials (BOM), information about past maintenance (contents of on-call maintenance, data about sensor signals on occurrence of an anomaly, date and time of adjustment, data about shot images, information about abnormal noise, information about replaced parts, and so on), a causal diagnosis tree (simple tree created by the designer and branching according to cases to identify units and parts required to be replaced), information about operational state, data about inspections during shipment or installation, and so forth.

Components shown in FIG. 23 are information regarding blocks of electrical parts. The feature of this configuration is that, through the use of a network indicating the relevance between sensor signals, component information is linked to the network, thus assisting a causal diagnosis. The network indicating the relevance between the sensor signals created from the degrees of effects of the sensor signals becomes a knowledge material for the causal diagnosis. In the diagnosis, based on the connectedness between phenomena within plural cases, locations, and elements (vague representation) indicating measures, a list of possible countermeasures is presented when such a phenomenon occurs.

In particular, in an example of medical instrument, for example, when a phenomenon such as generation of a ghost on an image occurs, connection with a cable being a component element is made using a network indicating the relevance between sensor signals, and shielding of the cable is presented as one list of possible countermeasures.

It is to be noted that the aforementioned linear prediction can be applied to learning data (learning data selected whenever a set of observational data is acquired), as well as to observational data.

Overall effects regarding the aforementioned embodiments are supplementarily described. For example, a company possessing electric power generation equipment hopes to reduce the cost of maintaining the equipment. Within the guarantee period, the equipment is inspected and replacement of parts is carried out. This is known as time-based equipment maintenance.

However, in recent years, we are shifting to state-based maintenance in which parts are replaced after checking the state of the equipment. In order to carry out the state maintenance, it is necessary to collect data indicating whether the equipment is normal or faulty. The amount and quality of the data determine the quality of the state maintenance.

However, in many cases, data on anomalies are collected rarely. As the equipment becomes greater in scale, it becomes more difficult to collect data on anomalies. Accordingly, it is important to detect outliers from normal data. The aforementioned embodiments yield the following direct advantageous effects:

(1) An anomaly can be detected from normal data.

(2) Even if data collection is incomplete, accurate anomaly detection is possible.

(3) If extraordinary data is contained, the effects are tolerable.

In addition, the embodiments yield the following secondary advantageous effects:

(4) It is easy for the user to visually grasp and understand abnormal phenomena.

(5) It is easy for the designer to visually grasp abnormal phenomena. It is easy to make them correspond to physical phenomena.

(6) It is possible to utilize engineers' knowledge.

(7) Physical models can also be used.

(8) Even an anomaly detection technique that places large computational load and requires a long processing time can be applied.

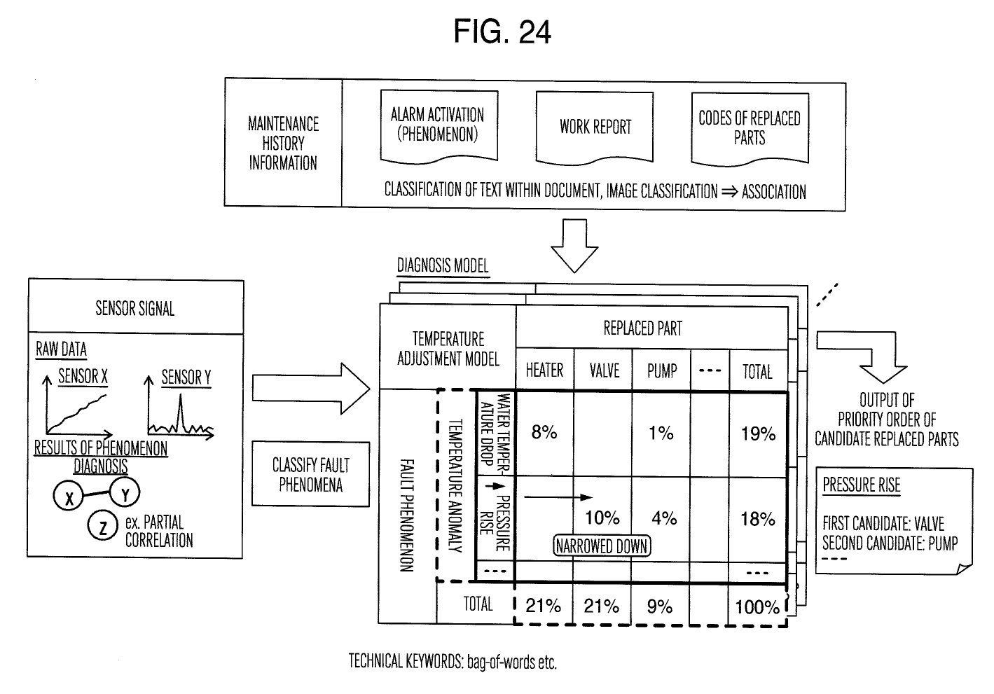

FIG. 24 shows an anomaly detection and diagnosis system consisting mainly of remote monitoring of the present invention. In FIG. 24, sensor signals from sensors mounted to equipment installed in a client's site are acquired remotely. Furthermore, when alarm activation occurs in response to a sensor signal, a serviceman goes to the client's site, makes a diagnosis, and makes an adjustment and replaces parts as necessary. The results of the diagnosis are compiled into a work report. The alarm activation includes a telephone communication from a client.

A problem presented here is utilization of past cases. During working at a client's site, if a phenomenon can be collated with the past cases, then diagnosis ends early and the downtime of the equipment is reduced to a short time. If an undesirable phenomenon cannot be represented with good wording or coding, the phenomenon cannot be collated with the past cases. Eventually, it is impossible to make use of the past cases.

Accordingly, in the present embodiment, the bag-of-words concept is used. That is, a histogram of frequencies of generation of keywords, codes, or words is created from codes of alarm activation, work report, and replaced parts. The distribution profile of the histogram is regarded as a feature and classified into categories. Similarly, sensor signals are classified into categories.

In the anomaly detection and diagnosis system of FIG. 24, an example of replaced parts is shown as a classification viewpoint. As the classification viewpoint, a category of other definition may be prepared. A pattern statistical method other than bag of words can be used.

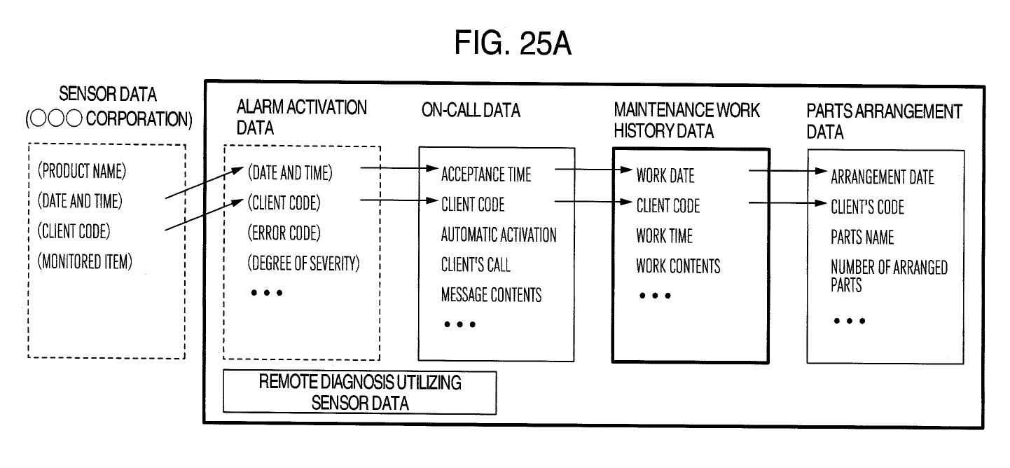

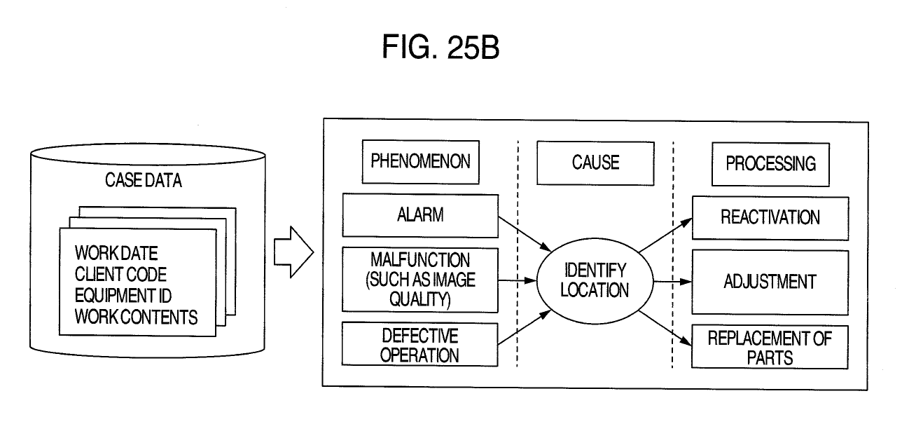

FIGS. 25A and 25B show details of maintenance history information of the anomaly detection and diagnosis system of FIG. 24 and association between alarm activation, work report, and maintenance history information about parts exchange data. In FIG. 25A, “on-call data” means data about a telephone communication.

FIG. 25B shows keywords in works such as phenomena, causes, and measures. The phenomena include alarm, malfunction (such as image quality), and defective operation and have more detailed classifications. The causes correspond to identification of a defective part.

Some of measures are corrected by reactivation, though not complete recovery. Some of measures require adjustments. Other measures lead to replacement of parts.

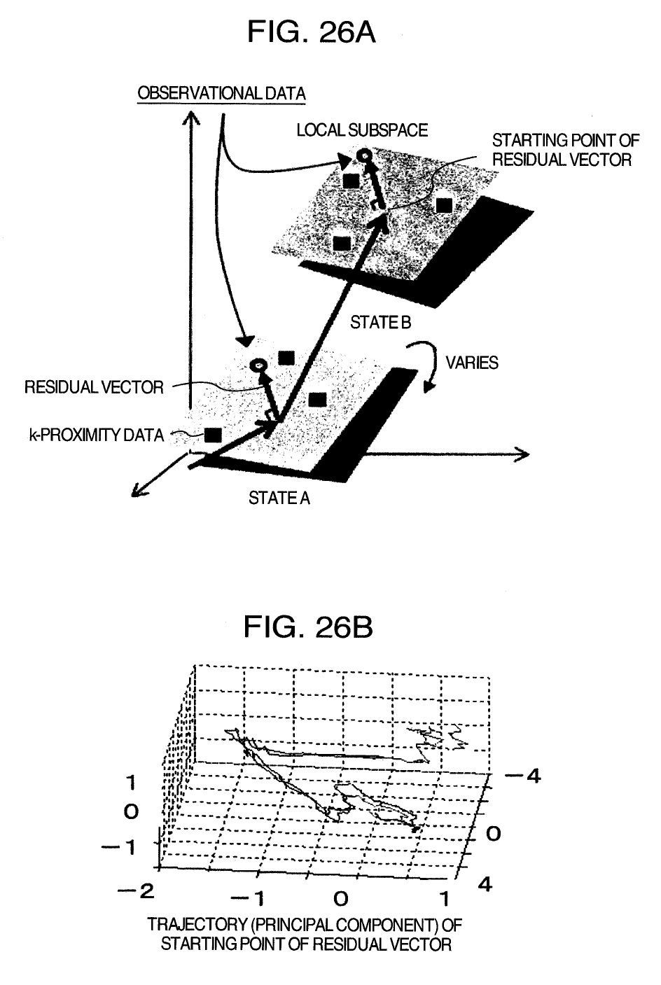

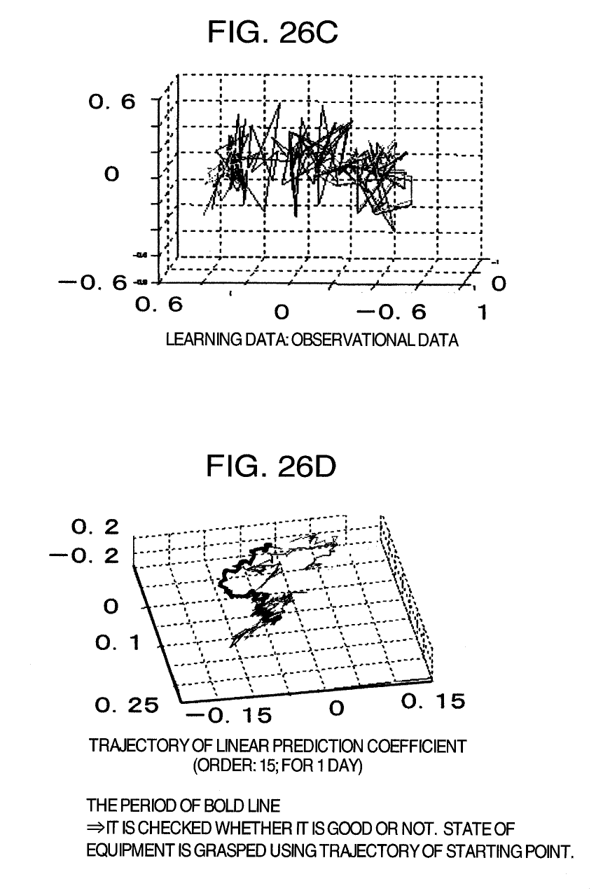

FIGS. 26A, 26B, 26C, and 26D are explanatory diagrams of trajectories of the starting point of a residual vector. In FIG. 26A, it is forecast that in a case where the state of equipment assumes two different types (A and B), the local subspace corresponds to the states A and B. For instance, the states A and B are respectively ON and OFF of operation or in different load conditions.

However, in each of the states A and B, variations such as seasonal variations may occur. FIG. 26B shows the seasonal variations. The figure shows the manner that observational data varies and learning data previously stored varies over a half year.

Therefore, the local subspace varies at each position. Accordingly, if the starting point of a residual vector is noticed, variations such as these state variations and seasonal variations can be represented.

FIG. 26C shows the trajectory of the starting point of a residual vector. This shows a trajectory corresponding to seasonal variations. As can be seen from the figure, the starting point of the residual vector shows variations which are different according to each period within a half year.

FIG. 26D shows linear prediction coefficients against the trajectory of the starting point of the residual vector. The bold line portion indicates that the starting point of the residual vector is fluid and that the direction is somewhat unstable.

In this way, if the trajectory of the starting point of the residual vector is noticed, it can be seen that the state of the equipment can be precisely represented. Subspaces in the states A and B, respectively, correspond to local subspaces of FIGS. 14 and 15.

In FIG. 11 already shown, the motion of the ending point of an anomaly measurement vector is represented. The time taken to reach the anomalous case A can be estimated if the velocity of motion of this vector is calculated. Alternatively, if the past motion of the ending point of the anomaly measurement vector leading to the anomalous case A is stored, the current state can be grasped during the course reaching the anomalous case A by collation with them. Hence, the time at which the anomaly occurred can be estimated.

Furthermore, in the example of FIG. 18, the motions of the “starting point” and “ending point” of the anomaly measurement vector are computed by the processor 119 and stored in the database 121. If observational data is newly entered, the processor 119 calculates motions of the “starting point” and “ending point” of the anomaly measurement vector, collates them against the past motions of the “starting point” and “ending point” of the anomaly measurement vector read from database 121, forecasts a date at which an anomaly will occur, and displays the date on the display portion 120. Anomaly information is attached to the data stored in the database 121.

Although the above-description has been provided in connection with embodiments, the present invention is not restricted thereto. It is obvious to those skilled in the art that various changes and modifications can be made within the scope of the spirit of the invention delineated by the appended claims.

### INDUSTRIAL APPLICABILITY

The present invention can be used as anomaly detection in plants and equipment.

### REFERENCE SIGNS LIST

11: multidimensional time-series signal acquisition portion
12: feature extraction/selection/conversion portion
13: identification devices
14: integration (outputs from plural identification devices are combined. A global anomaly measurement is output.)
15: learning database consisting mainly of normal cases (to select learning data)
16: clustering
24: extraction and classification of features of time series signal
25: symptom detection
26: anomaly diagnosis
119: processor
120: display portion
121: database (DB)

1. An anomaly detection method for early detecting an anomaly or a fault in a plant or equipment, said method comprising the steps of:
acquiring data from a plurality of sensors;
modeling learning data consisting mostly of normal data;
calculating an anomaly measurement of the acquired data using the modeled learning data;
modeling time-sequential behavior of the acquired data by linear prediction;
calculating prediction errors from the models; and
detecting whether there is an anomaly or a fault using both the anomaly measurement and the prediction errors.

2. The anomaly detection method according to claim 1, said method further comprising the steps of:
calculating an anomaly measurement of the acquired data as a vector using the modeled learning data;
calculating prediction errors from the models as a prediction error vector; and
detecting whether there is an anomaly or a fault using a combination of the anomaly measurement vector and the prediction error vector.

3. An anomaly detection method for early detecting an anomaly or a fault in a plant or equipment, said method comprising the steps of:
acquiring data from a plurality of sensors;
preparing given orders or determining orders based on distances between data sets whenever data is acquired;
modeling the acquired data by linear prediction;
calculating a prediction error from the model; and
detecting whether there is an anomaly or a fault.

4.-10. (canceled)

11. An anomaly detection system for early detecting an anomaly or a fault in a plant or equipment, wherein
data is acquired from a plurality of sensors;
learning data consisting mostly of normal data is modeled;
an anomaly measurement of the acquired data is calculated using the modeled learning data;
time-sequential behavior of the acquired data is modeled by linear prediction;
prediction errors from the models are calculated; and
is detected as to whether there is an anomaly or a fault, using both anomaly measurement and prediction errors.

12. The anomaly detection system according to claim 11, wherein
an anomaly measurement of the acquired data is calculated as a vector using the modeled learning data,
prediction errors from the models are calculated as a prediction error vector, and
it is detected as to whether there is an anomaly or a fault, using a combination of the anomaly measurement vector and the prediction error vector.

13.-15. (canceled)
